(19) United States
(12) Patent Application Publication
(10) Pub. No.: US 2005/0099524 A1
(43) Pub. Date: May 12, 2005

(54) Optical instrument with digital camera

(75) Inventors: Makoto Mogamiya, Tokyo (JP); Toshio Masuda, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/981,785

(22) Filed: Nov. 5, 2004

(30) Foreign Application Priority Data
Nov. 6, 2003 (JP) 2003-377601

(51) Int. Cl. H04N 5/232

(52) U.S. Cl. 348/345

(57) ABSTRACT

An optical instrument, which includes an imaging optical system, an imaging device, a focus driving system that relatively moves an image forming position of the object image with respect to a receiving surface of the imaging device, and a controller that controls the imaging device and the focus driving system. The controller obtains., in one shooting operation, continuously a normal photographing image and at least one focus corrected:image which is captured when an object image of a certain color component is properly focused on the receiving surface of the imaging device. Light of the certain color component causes a longitudinal spherical aberration when passing through the imaging optical system.

### BACKGROUND OF THE INVENTION

The present invention relates to an optical instrument with a digital camera, such as a telescope main body and a spotting scope having a digital camera.

A telescope (spotting scope) with a digital camera is known, which is capable of shooting an electronic image that is the same as a visual image viewed through an eyepiece thereof. Such a telescope is disclosed, for example, in a Japanese Utility Model Publication No.3074642 (hereafter, referred to as a document 1). The telescope with a digital camera is provided with a beam splitter for splitting a light beam that has passed through an objective optical system and a focusing lens, and leading one of the split beam to an ocular optical system and the other to an imaging device such as a CCD (charge coupled device) imaging device.

In general, an optical instrument employs an achromatic lens so that a longitudinal chromatic aberration for light having a wavelength range of 500 nm through 600 nm (i.e., green light through orange light) is reduced. Although a longitudinal spherical aberration caused by light having a wavelength longer than or shorter than the wavelength range of 500 through 600 nm (i.e., blue light or red light) remains by use of the achromatic lens, such remaining longitudinal spherical aberration does not raise a problem when the achromatic lens is used in a normal photographing lens because of a relatively short focal length of the normal photographing lens.

However, when the achromatic lens is used in a telescope with a digital camera having a relatively long focal length, the use of the achromatic lens raises a problem that the remaining longitudinal spherical aberration affects imaging quality. If the remaining longitudinal spherical aberration of blue light or red light is caused, such a remaining longitudinal spherical aberration does not raise a problem in observing a visual image viewed through an eyepiece of the telescope with a digital camera.

The reason is that spectral sensitivity of human eyes to light having a constant intensity varies depending on a wavelength of the light. The human eyes have the highest sensitivity to green light, and have relatively low sensitivity to blue or red light. Therefore, if green, blue and red objects have the same intensity, a person recognizes that the green object is brightest. That is, human eyes have low visibility for red or blue light relative to green light.

For this reason, a person observing the visual image through the eyepiece does not recognize occurrence of the longitudinal spherical aberration of red and blue light.

By contrast, the imaging device has substantially the same sensitivity for blue, red and green light, and is thereby affected by the remaining longitudinal spherical aberration caused by blue and red light. Typically, an imaging device is used together with an infrared filer. Therefore, an effect of the longitudinal spherical aberration caused by red light can be suppressed.

However, the longitudinal spherical aberration caused by blue light affects the imaging quality of the imaging device in such a manner that a captured electronic image has color halation (e.g., blue or purple halation).

As described above, the conventional telescope with a digital camera has a problem that blue or purple halation may occur in an electronic image captured by the imaging device due to the remaining longitudinal spherical aberration of blue or red light even though such a remaining longitudinal spherical aberration is not recognized from an visual image viewed through the eyepiece.

Use of low dispersion glass as an optical lens may resolve the problem mentioned above; however, such a low dispersion glass is very expensive and increases manufacturing cost of the telescope with a digital camera.

### SUMMARY OF THE INVENTION

The present invention is advantageous in that it provides an optical instrument with a digital camera configured to prevent an electronic image form being affected by a longitudinal spherical aberration, without increasing cost and complexity thereof.

According to an aspect of the invention, there is provided an optical instrument, which is provided with an imaging optical system, an imaging device that captures an object image formed through the imaging optical system, a focus driving system that relatively moves an image forming position of the object image with respect to a receiving surface of the imaging device, and a controller that controls the imaging device and the focus driving system. In this structure, the controller obtains, in one shooting operation, continuously a normal photographing image and at least one focus corrected image which is captured when an object image of a certain color component is properly focused on the receiving surface of the imaging device. Light of the certain color component causes a longitudinal spherical aberration when passing through the imaging optical system.

Since the normal photographing image and the focus corrected image are obtained in one shooting operation, it becomes possible to generate an aberration corrected image in which color halation caused by the longitudinal spherical aberration is sufficiently corrected by a combining operation performed in the optical instrument or a combining operation performed in an external computer, without increasing cost and complexity of the optical instrument.

Optionally, the controller may operate to move the image forming position of the certain color component to the receiving surface of the imaging device based on correction data stored in the optical instrument so as to obtain the focus corrected image.

Still optionally, the certain color component may include one of a red component and a blue component.

According to another aspect of the invention, there is provided a telescope main body, which is provided with an objective optical system, a focusing system including a focus adjusting member to be manipulated for focusing and a focusing lens which moves along a direction of an optical axis by operation of the focus adjusting member, and an imaging device which captures an object image formed through the objective optical system and the focusing lens. The telescope main body is further provided with a beam splitter which splits an optical path through the focusing lens into a first optical path directed to the imaging device and a second optical path directed to an ocular optical system provided in an eyepiece which is detachably attached to the telescope main body, a focus driving system that relatively moves an image forming position of the object image with respect to a receiving surface of the imaging device, and a controller that controls the imaging device and the focus driving system.

In this structure, the controller obtains, in one shooting operation, continuously a normal photographing image and at least one focus corrected image which is captured when an object image of a certain color component is properly focused on the receiving surface of the imaging device. Light of the certain color component causes a longitudinal spherical aberration when passing through the imaging optical system.

Since the normal photographing image and the focus corrected image are obtained in one shooting operation, it becomes possible to generate an aberration corrected image in which color halation caused by the longitudinal spherical aberration is sufficiently corrected by a combining operation performed in the telescope main body or a combining operation performed in an external computer, without increasing cost and complexity of the telescope main body.

Optionally, the telescope main body may be provided with a focus adjusting optical system located on the first optical path.

Still optionally, the focus driving system moves the focus adjusting optical system with respect to the imaging device in a predetermined direction.

Still optionally, the controller may operate to drive the focus adjusting optical system through the focus driving system to move the image forming position of the certain color component to the receiving surface of the imaging device based on correction data stored in the telescope main body so as to obtain the focus corrected image.

Still optionally, an imaging optical system may be formed by optical components including the objective optical system, the focusing lens and at least one other optical component located between the objective optical system and the receiving surface of the imaging device, and a focal length of the imaging optical system may be not less than 800 mm on the basis of a 35 mm film.

With regard to the above mentioned two aspects of the invention, the optical instrument and the telescope main body may be further provided with an image generating system that generates an aberration corrected image by combining image data of the certain color component in the at least one focus corrected image and image data of a color component other than the certain color component in the normal photographing image.

In a particular case, the color component other than the certain color component may include a green component.

In a particular case, the certain color component may include a blue component.

According to another aspect of the invention, there is provided a telescope, which is provided with an ocular optical system, an objective optical system, a focusing system including a focus adjusting member to be manipulated for focusing and a focusing lens which moves along a direction of an optical axis by operation of the focus adjusting member, and an imaging device which captures an object image formed through the objective optical system and the focusing lens. The telescope is further provided with a beam splitter which splits an optical path through the focusing lens into a first optical path directed to the imaging device and a second optical path directed to the ocular optical system, a focus driving system that relatively moves an image forming position of the object image with respect to a receiving surface of the imaging device, and a controller that controls the imaging device and the focus driving system.

In this structure, the controller obtains, in one shooting operation, continuously a normal photographing image and at least one focus corrected image which is captured when an object image of a certain color component is properly focused on the receiving surface of the imaging device. Light of the certain color component causes a longitudinal spherical aberration when passing through the imaging optical system.

Since the normal photographing image and the focus corrected image are obtained in one shooting operation, it becomes possible to generate an aberration corrected image in which color halation caused by the longitudinal spherical aberration Is sufficiently corrected by a combining operation performed in the telescope or a combining operation performed in an external computer, without increasing cost and complexity of the telescope main body.

### BRIEF DESCRIPTION OF THE ACCOMPANYING DRAWINGS

FIG. 1 is a perspective front view showing a telescope main body according to an embodiment of the present invention;

FIG. 2 is a perspective rear view showing the telescope main body of FIG. 1;

FIG. 3 is a cross-sectional side view showing the telescope main body of FIG. 1;

FIG. 4 is a perspective exploded view showing an optical system of a telescope according to the embodiment of the present invention;

FIG. 5 is a side view showing a prism unit viewed from an opposite side of FIG. 3;

FIG. 6 is a block diagram showing a configuration of the telescope main body of FIG. 1;

FIG. 7 is a flowchart showing a main controlling operation of the spotting scope according to the embodiment of the present invention;

FIG. 8 is a flowchart showing a menu setting subroutine;

FIG. 9 shows transition of screen displays in the menu setting process; and

FIG. 10 is a graph illustrating spectral luminous efficiency for photopic vision, spectral sensitivity of a CCD imaging device and spectral transmittance of an infrared cut filter.

### DETAILED DESCRIPTION OF THE EMBODIMENTS

Referring to the accompanying drawings, preferable embodiments of an optical instrument with a digital camera according to the present invention will be described hereunder. As examples of the optical instrument, a telescope main body and a spotting scope is explained hereafter.

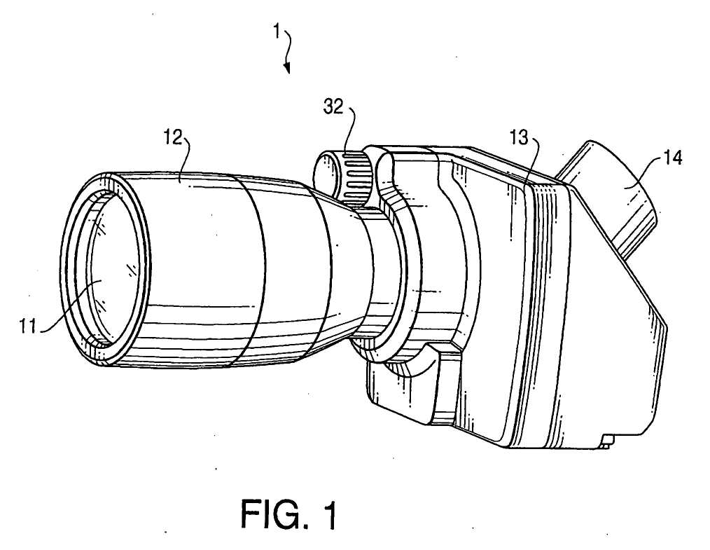

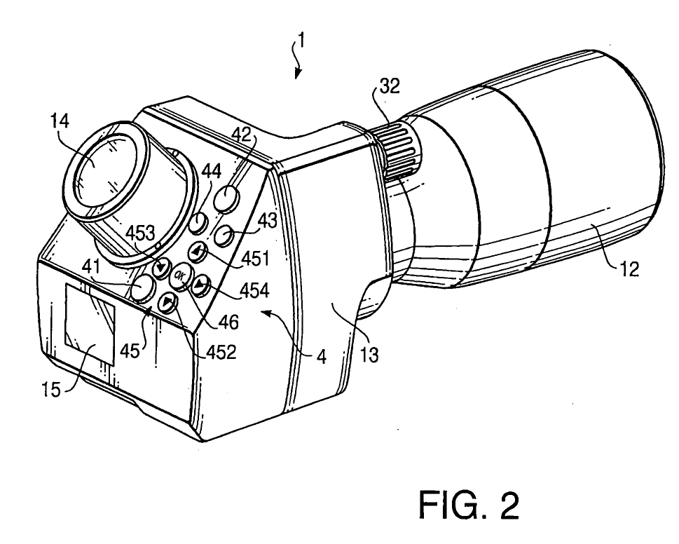

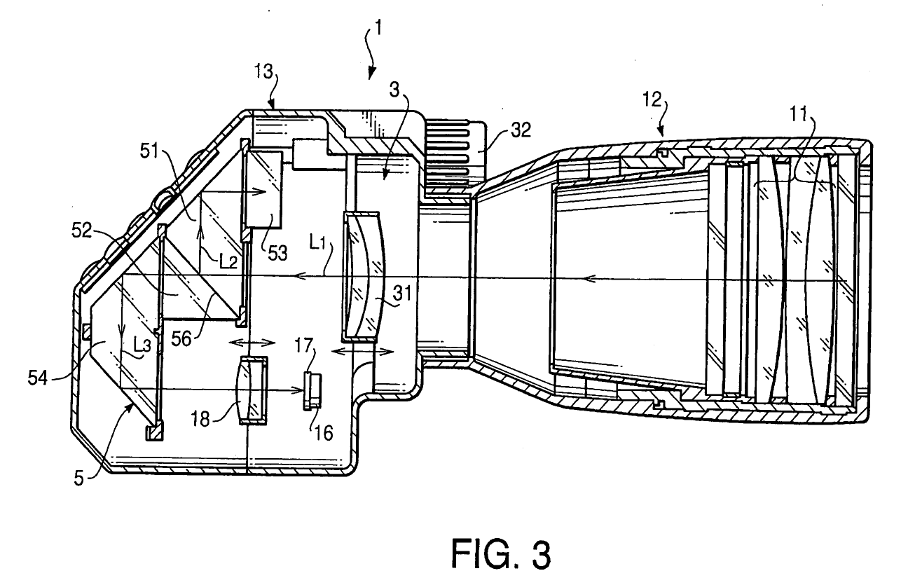

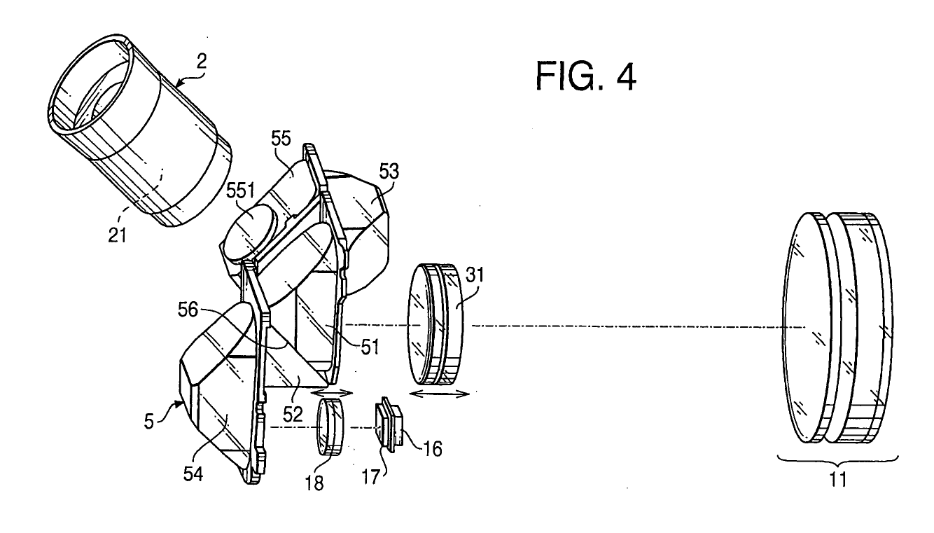

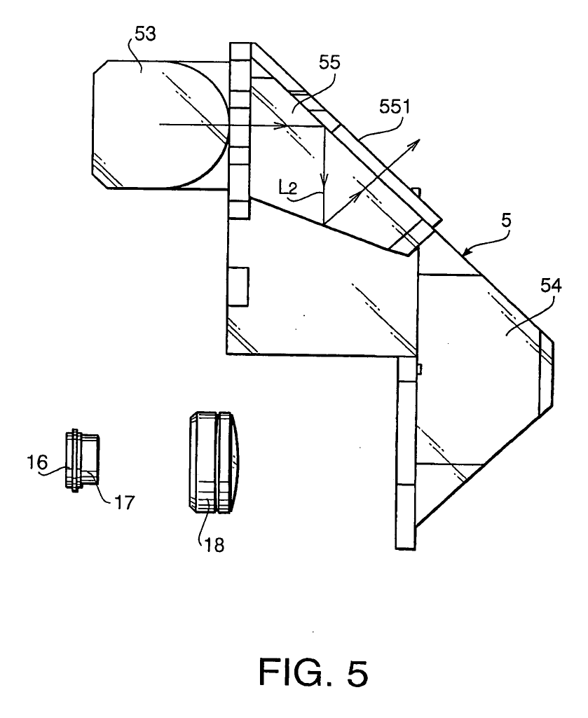

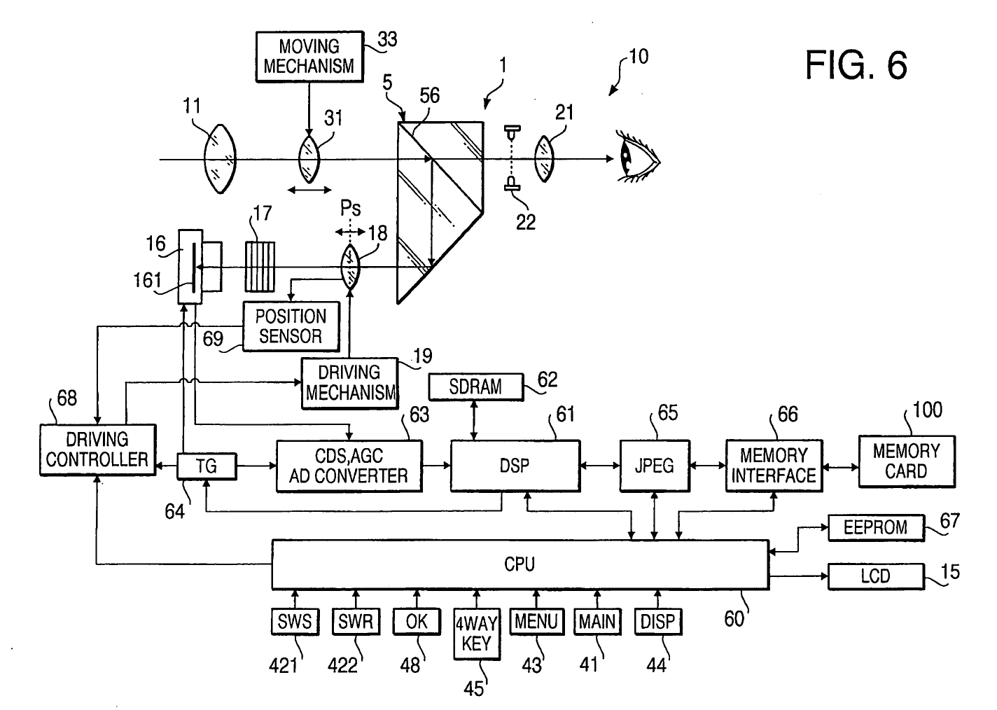

FIG. 1 is a perspective front view showing a telescope main body according to the embodiment of the present invention; FIG. 2 is a perspective rear view showing the telescope main body of FIG. 1; FIG. 3 is a cross-sectional side view showing the telescope main body of FIG. 1; FIG. 4 is a perspective exploded view showing an optical system of the spotting scope according to the present invention; FIG. 5 is a side view showing a prism unit viewed from an opposite side of FIG. 3; and FIG. 6 is a block diagram showing a configuration of the telescope main body of FIG. 1.

The telescope main body 1 according to the embodiment shown in these drawings is to be combined with an eyepiece 2, to thereby constitute a spotting scope 10 (see FIG. 6). The spotting scope 10 can be suitably utilized for various purposes, typically for bird watching.

As shown in FIG. 1, the telescope main body 1 is provided with a lens barrel 12 containing therein an objective optical system 11 and a casing 13 located at a base portion of the lens barrel 12. The casing 13 is provided with a focusing ring 32 rotatably disposed in an upper region of a front face thereof, for serving as a focus adjusting device.

Referring to FIG. 2, the casing 13 is provided, on a rear face thereof, with an eyepiece mounting base 14 to which the eyepiece 2 can be detachably mounted, a display panel 15 and various operating buttons 4.

On the eyepiece mounting base 14, the eyepiece 2 containing therein an ocular optical system 21 as shown in FIG. 4 can be detachably mounted. Replacing the eyepiece 2 with another having a different focal length can change a magnification of the spotting scope 10. Also, the eyepiece mounting base 14 accepts a variable focus type (zoom type) eyepiece.

While the drawings show an angle type spotting scope in which an optical axis of the eyepiece 2 mounted on the eyepiece mounting base 14 is upwardly inclined with respect to an optical axis of the objective optical system 11 by a predetermined angle, the scope of the present invention is not limited to such type. The present invention may also be applied to a straight type spotting scope in which both optical axes are parallel to each other.

In this embodiment, the eyepiece 2 is detachable attached to the telescope main body 1, the telescope main body 1 may alternatively be configured such that an eyepiece is integrally formed with a telescope main body.

The display panel 15 is constituted of for example a liquid crystal display device. The display panel 15 can display a menu screen, a setting screen of different modes, an image captured by a CCD (Charge Coupled Device) imaging device 16 to be described later, and so forth.

Referring to FIG. 2, the operating buttons 4 include a main switch 41 for turning on and off the power, a release button 42, a menu key 43, a display key 44 for switching on and off the display panel 15, an up key 451, a down key 452, a left key 453 and a right key 454 respectively for moving a cursor displayed on the display panel 15, and an OK button 46 for entering a selected item.

Referring to FIG. 3, the lens barrel 12 contains the objective optical system 11 in the proximity of a front end portion thereof. Also, a focusing lens (focus adjusting lens) 31 is coaxially placed with respect to the objective optical system 11, in the casing 13. The focusing lens 31 moves along a direction of the optical axis by a manipulation of the focusing ring 32, so as to adjust a focus. A focusing lens moving mechanism 33 (not shown in FIG. 3) for converting a rotational movement of the focusing ring 32 into a rectilinear movement of the focusing lens 31 may be a barrel cam mechanism or a feed screw mechanism etc. The focusing lens 31, the focusing ring 32 and the focusing lens moving mechanism 33 constitute a focusing system 3.

In the casing 13, a prism unit 5 is disposed behind the focusing lens 31. The prism unit 5 includes a first right-angle prism 51, a second right-angle prism 52, a third right-angle prism 53, a fourth right-angle prism 54 and a prism 55.

A short side surface of the first right-angle prism 51 and the long side surface of the second right-angle prism 52 are joined, and the joint plane constitutes a beam splitter 56. Also, as shown in FIG. 4, the prism 55 is provided with an emergence plane 551, through which a light beam proceeds toward the ocular optical system 21 (eyepiece mounting base 14).

Referring further to FIG. 3, a light beam that has passed through the objective optical system 11 and the focusing lens 31 first enters the first right-angle prism 51. An optical path L1 of this light beam is split at the beam splitter 56 into a first optical path L2 directed to the ocular optical system 21 and a second optical path L3 directed to the CCD imaging device 16.

The first optical path L2 directed to the ocular optical system 21 turns its direction by 180 degrees because of reflection at the beam splitter 56 as well as the other short side plane of the first right-angle prism 51. The first optical path L2 is then reflected twice in the third right-angle prism 53 thus to turn its direction again by 180 degrees. Further, as shown in FIG. 5, the first optical path L2 is reflected twice in the prism 55, to thereby upwardly incline and to finally proceed to the ocular optical system 21 through the emergence plane 551.

The first right-angle prism 51 and the third right-angle prism 53 constitute an erecting optical system (porro prism). For this reason an erected image can be observed through the eyepiece 2.

Back to FIG. 3, the second optical path L3 directed to the CCD imaging device 16 passes through the beam splitter 56 to enter the fourth right-angle prism 54, and is reflected twice in the fourth right-angle prism 54 to thereby turn its direction by 180 degrees and to proceed forward.

The casing 13 also accommodates therein the CCD imaging device 16, an optical filter unit 17 and a reducing optical system 18.

The CCD imaging device 16 is disposed at a position appropriate for receiving a light beam that has come along the second optical path L3, to thereby capture an image obtained through the objective optical system 11 and the focusing lens 31. As a result of such configuration, the spotting scope 10 can shoot an electronic image identical to a visual image viewed through the eyepiece 2, with the CCD imaging device 16. It should be noted that another imaging device such as a CMOS sensor or the like may be used in place of the CCD imaging device 16.

The optical filter unit 17 is attached to the CCD imaging device 16 so as to face a receiving surface 161 thereof. The optical filter unit 17 is formed by a lamination of an optical low-pass filter and an infrared cut filter. The optical low-pass filter serves to reduce a spatial frequency component close to a sampling spatial frequency determined by a pixel spacing of the CCD imaging device 16, out of a spatial frequency of a light beam of an object. The optical low-pass filter serves to prevent emergence of a moire, and the infrared cut filter serves to exclude an infrared frequency component. Providing the infrared cut filter permits preventing the CCD imaging device 16 from receiving an infrared light beam which is invisible to human eyes.

The reducing optical system 18 is placed between the fourth right-angle prism 54 and the combination of the CCD imaging device 16 and the optical filter unit 17. A light beam from the focusing lens 31 that has proceeded along the second optical path L3 is downscaled by the reducing optical system 18 so as to fit a size of the CCD imaging device 16, to thereby form an image on the receiving surface 161 of the CCD imaging device 16.

As described above, the telescope main body 1 is provided with the imaging optical system for the CCD imaging device 16, constituted of the entire optical system disposed between the objective optical system 11 to the receiving surface 161 of the CCD imaging device 16, inclusive of the former, namely the objective optical system 11, the focusing lens 31, the beam splitter 56, the reducing optical system 18 and the optical filter unit 17.

It is preferable that the imaging optical system has a focal length of not less than 800 mm on the basis of a 35 mm film. Here, a focal length on the basis of a 35 mm film means a focal length that forms an object image of a same picture angle on the receiving surface of the CCD imaging device 16, assuming that an effective receiving area of the CCD imaging device 16 is enlarged to the exposure area of a 35 mm silver halide film (36 mm×24 mm).

On the other hand, an upper limit of the focal length of the imaging optical system is not specifically determined; however from the viewpoint of a practical use, a maximum focal length of the imaging optical system of the telescope according to the embodiment of the present invention may be approx. 20000 mm on the basis of a 35 mm film.

The reducing optical system 18 is movably disposed, and is driven by a reducing optical system driving mechanism 19 so as to move in a direction of the optical axis (Ref. FIG. 6). The reducing optical system driving mechanism 19 according to the embodiment includes, though not shown in details, a feed screw and a stepping motor for rotating the feed screw, to thereby rectilinearly drive the reducing optical system 18. Operation of the reducing optical system driving mechanism 19 is controlled by a reducing optical system driving controller 68.

When the reducing optical system 18 moves in a direction of the optical axis, an image forming position of an object image formed through the objective optical system 11 and the focusing lens 31 moves with respect to the receiving surface 161 of the CCD imaging device 16, in a direction of the optical axis. Accordingly, the reducing optical system 18 serves as a focus adjusting optical system for the CCD imaging device 16, which adjusts a focus of an object image on the receiving surface 161 of the CCD imaging device 16. Likewise, the reducing optical system driving mechanism 19 serves as a focus driving system which relatively moves the image forming position of the object image with respect to the receiving surface 161 in a direction of the optical axis (i.e., the optical axis of the reducing optical system 18).

Here, the focus driving system according to the embodiment of the present invention may be constituted, without limitation to the above, so as to move the CCD imaging device 16 in a direction of the optical axis, thus to relatively move the image forming position with respect to the receiving surface 161. In this embodiment the reducing optical system 18 is moved for focus adjustment, since such design better simplifies the structure.

The reducing optical system 18 is provided with a position sensor 69 for detecting that the reducing optical system 18 is at a reference position Ps. An output signal of the position sensor 69 is input to the reducing optical system driving controller 68. When the reducing optical system 18 is at the reference position Ps, the receiving surface 161 is located at a position that is optically equivalent to a field frame 22 (target focus position) of the eyepiece 2.

Now referring to FIG. 6, from the viewpoint of electric configuration, the telescope main body 1 is provided with a CPU (Central Processing Unit) 60, a DSP (Digital Signal Processor) 61, an SDRAM (Synchronous bynamic Random Access Memory) 62, an image signal processor 63, a timing generator 64, an image data compressor 65, a memory interface 66, and an EEPROM (Electrically Erasable Programmable Read-Only Memory) 67. In addition, the casing 13 accommodates therein a slot (not shown) in which a memory card (storage medium) 100 can be loaded.

The CPU 60 serves for integrally controlling the telescope main body 1 based on a preinstalled program and input signals from the operating buttons etc., and performs various controlling operations such as a photographic control, a control over the reducing optical system driving controller 68 and so forth.

The DSP 61 is engaged in driving control of the CCD imaging device 16 and integral control of image processing and storing, including generation of image data based on a pixel signal from the CCD imaging device 16, compression of the image data, storing the image data in the memory card 100, etc., through mutual communication with the CPU 60 for collaboration in these jobs.

The SDRAM 62 includes operating regions for image data generation etc. and regions for the display panel 15 etc., which are determined in advance.

The timing generator 64 is controlled by the DSP 61, to output a sample pulse etc. to the CCD imaging device 16, the image signal processor 63 and the reducing optical system driving controller 68, for controlling an operation thereof.

On the display panel 15, a live view (monitor display) of a real-time image captured by the CCD imaging device 16, which is the same as the visual image viewed through the eyepiece 2, is displayed as described in the following process. The object image formed on the receiving surface 161 of the CCD imaging device 16 is photoelectrically converted into electrical charge data, and such charge data (signal) is sequentially read out from the CCD imaging device 16 with a portion corresponding to a predetermined number of pixels thinned out, for reproducing a live view image.

Further, the signal undergoes a correlative double sampling (CDS), automatic gain control (AGC) and analog/digital conversion in the imaging signal processor 63, to then be input to the DSP 61. In the DSP 61, a predetermined signal processing including color processing and gamma correction etc. is performed on the input signal, to thereby generate a live view image data (luminosity signal Y, two color difference signals Cr, Cb).

The live view image data includes a fewer number of pixels (because of the thinning out) than the number of effective pixels of the CCD imaging device 16, in accordance with the number of pixels of the display panel 15, so that the display panel can display an image according to such live view image data. The generation of the live view image data is periodically updated each time the data is read out from the CCD imaging device 16, so that the image is displayed on the display panel 15 as a real-time motion picture.

The spotting scope 10 configured as above is designed such that a visual image viewed through the eyepiece 2 is to be recognized as correctly focused when an image forming position (aerial image) of the visual image has reached a position of the field frame 22 by manipulation of the focusing ring 32. In other words, the user is expected to manipulate the focusing ring 32 for focusing purpose such that an image formed at a position of the field frame 22 (target focus position) becomes clearly seen.

By pressing the release button 42 when the user views an visual image to be photographed, the user can store an electronic image identical to the visual image viewed through the eyepiece 2. As already described, since the receiving surface 161 of the CCD imaging device 16 is at a position optically equivalent to the position of the field frame 22 (target focus position) when the reducing optical system 18 is at the reference position Ps, the same object image is also formed on the receiving surface 161 of the CCD imaging device 16 once the focus is adjusted as above. Therefore, upon shooting the image under such state, a correctly focused picture is supposed to be obtained.

As described above, the object image formed through the imaging optical system has a longitudinal spherical aberration, the image forming position of the object image varies among color components (i.e., wavelengths). Therefore, all of the object images of respective color components are not completely focused on the receiving surface 161 of the CCD imaging device 16.

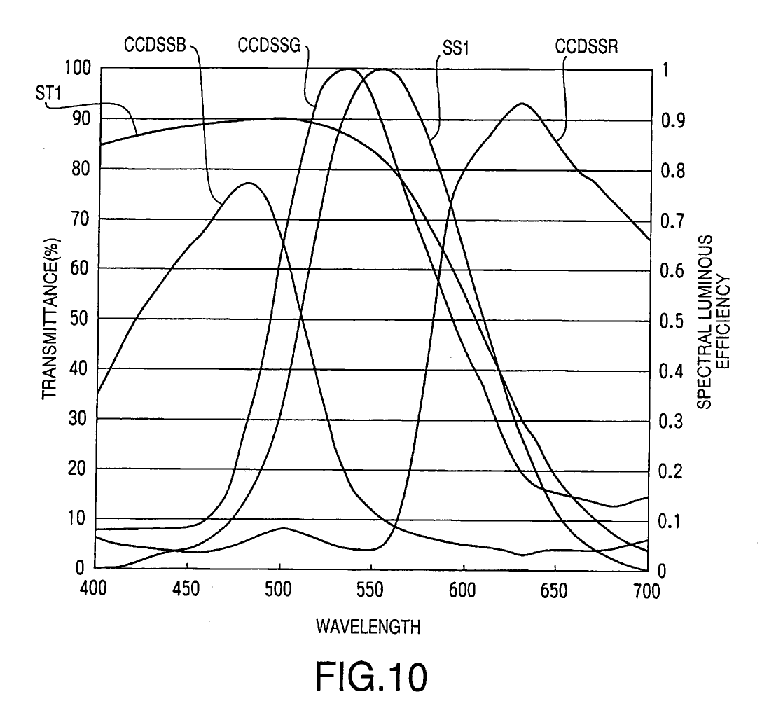

Typically, the object image of a green component (i.e., wavelength in the vicinity of 520 nm) is properly focused on the receiving surface 161 when the focus adjustment by the focusing ring 32 is attained. The reason is that the human eyes have the highest sensitivity for green light as indicated in a spectral luminous efficiency for photopic vision SS1 in FIG. 10. That is, in a normal photographing situation, the object images of blue and red component are sifted from the object image of a green component by an amount corresponding to the amount of the longitudinal spherical aberration from a focal point of the object image of a green component.

Since the amount of the longitudinal spherical aberration changes in proportion to a focal length of the imaging optical system, a focal shift of blue or red light becomes larger in particular in an imaging optical system having a long focal length of a telescope (such as a spotting scope 10). However, a user hardly recognizes such focal shifts of blue and red light because as mentioned above human eyes have relatively low sensitivity to blue and red light as indicated by the spectral luminous efficiency for photopic vision SS1.

By contrast, as indicated by a spectral sensitivity of the CCD imaging device 16 (a relative sensitivity of blue pixels CCDSSB, a relative sensitivity of green pixels CCDSSG, and a relative sensitivity of red pixels CCDSSR in FIG. 10), the CCD imaging device 16 has relatively high sensitivity for blue and red light as well as green light. Therefore, an electronic image captured by the CCD imaging device 16 may have blue, purple or red halation due to the focal shift of blue and red light. To solve such a problem, the telescope main body 1 (the spotting scope 10) is configured as follows.

The telescope main body 1 is configured to simultaneously capture a normal photographing image (captured in the normal photographing situation) and a focus corrected image at one shooting. The focus corrected image is an image captured when an object image of a particular light component (e.g., blue or red component) is properly focused on the receiving surface 161 of the CCD imaging device 16. Therefore, the object is properly focused in the focus corrected image with regard to the particular light component.

By combining the normal photographing image and the focus corrected image obtained simultaneously, it becomes possible to obtain a high quality image having no color halation, as described in detail below.

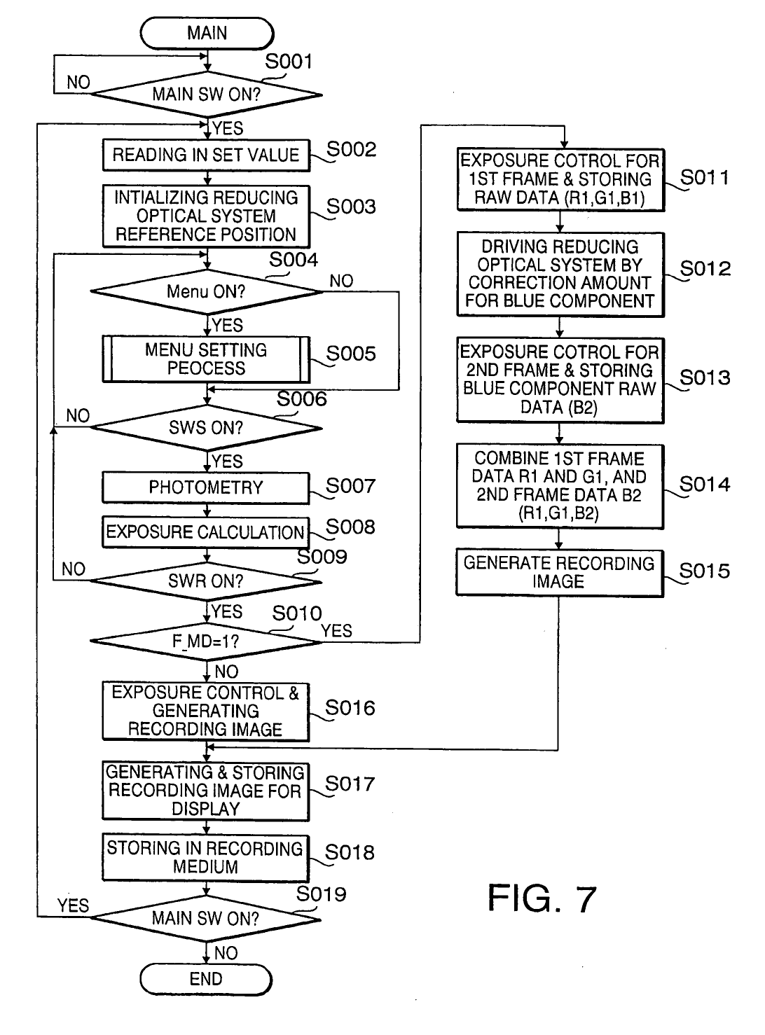

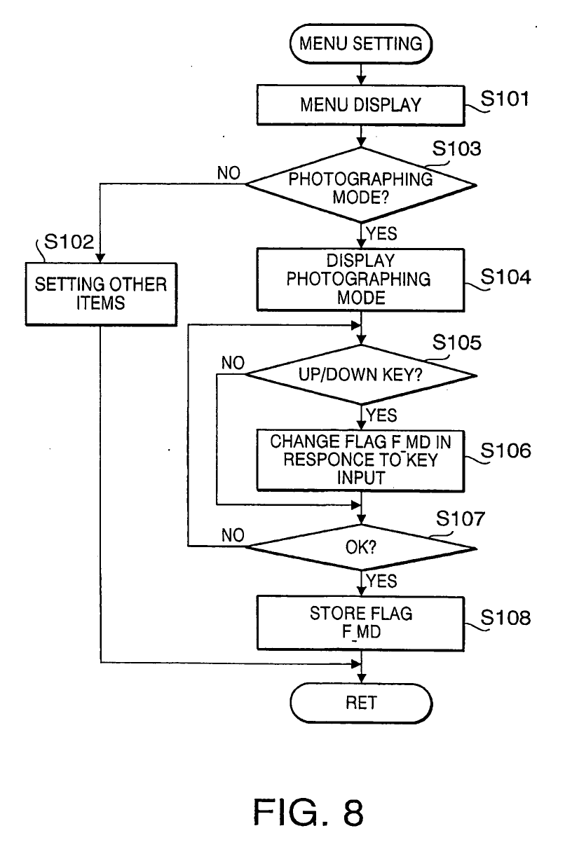

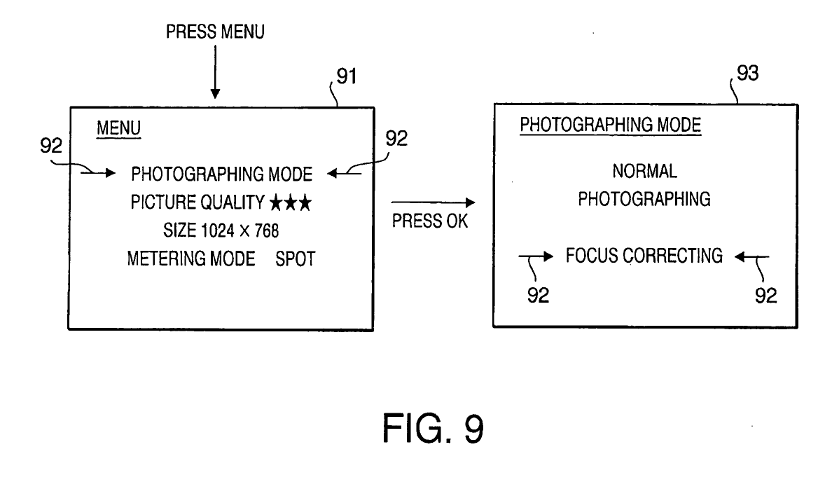

Hereafter, operation of the telescope main body 1 (the spotting scope 10) will be explained in detail. FIG. 7 is a flowchart showing a main controlling operation of the spotting scope 10 according to the embodiment; FIG. 8 is a flowchart showing a menu setting process subroutine; FIG. 9 shows screen displays in the menu setting process.

Once the main switch 41 is pressed in an off state to turn the power on (step S001 of FIG. 7), the CPU 60 is activated and reads in various set values (step S002). The CPU 60 then drives the reducing optical system driving mechanism 19 through the reducing optical system driving controller 68, to thereby move the reducing optical system 18 to the reference position Ps (step S003), and performs the initialization.

Here, the CPU 60 controls, upon moving the reducing optical system 18, a driving direction K and a driving distance A so as to recognize an absolute position (actual position) of the reducing optical system 18. The driving direction K is defined as plus (+) for a predetermined direction (for example a direction separating from the CCD imaging device 16) and minus (−) for the opposite direction, for controlling purpose. The driving distance Δ can be controlled according to the number of driving pulses provided to a stepping motor of the reducing optical system driving mechanism 19.

Also, the reducing optical system driving mechanism 19 is designed so as to move the reducing optical system 18 by half a length of a focal depth of the imaging optical system, with each input of a driving pulse. For example, in the case where a focal depth of the imaging optical system is 12 μm, the reducing optical system 18 moves 6 μm with an input of a driving pulse to the reducing optical system driving mechanism 19, and two driving pulses are necessary in order to move the reducing optical system 18 over a distance equal to the focal depth.

In this embodiment, the spotting scope 10 has two selectable photographing modes: a normal photographing mode in which only a normal photographing image is obtained as one still image, and a focus correcting photographing mode in which a normal photographing image and a focus corrected image are captured continuously in one shooting operation. One of the photographing modes are selected as follows.

In step S004, it is judged whether or not the menu key 43 is pressed. If the menu key is pressed (S004:YES), the menu setting process is performed (S005). The menu setting process is shown in FIG. 8. As shown in FIG. 8, firstly the CPU 60 controls an onscreen display circuit (not shown in FIG. 6) to display a main menu screen 91 on the display 15 (S101).

By moving a cursor 92 by operation of the up key 451 and down key 452, the user can select one of items of “photographing mode”, “image quality”, “size” and “metering mode”. Placing the cursor 92 on one of the letters of “image quality”, “size” and “metering mode” and pressing the OK button 46 leads to setting process of the respective items (S103:NO, S102), the description on which however, will be omitted.

Placing the cursor 92 on the letters of “photographing mode” and pressing the OX button 46 leads to setting process of the photographing mode (S104). In step S104, a photographing mode setting screen 93 is displayed on the display 15. As shown in FIG. 9, two items “normal photographing” and “focus correcting” are displayed. The CPU 60 controls a flag F_MD which is set to 0 when the normal photographing mode is selected and is set 1 when the focus correcting photographing mode is selected.

A default value of the flag F_MD is zero and the cursor 92 is located at the letters “normal photographing” at a start of the photographing mode setting screen 93. IF the up key 451 or down key 452 is pressed for selection (S105:YES), the cursor 92 moves up or down, and the flag F_MD is switched to a value of the corresponding photographing mode (S106). Then control proceeds to S107. When it is determined in step S105 that the up key 451 and down key 452 are not pressed (S105:NO), control proceeds to step S107.

In step S107 is judged whether the OK key button 46 is pressed. If the OK button 46 is pressed (S107:YES), the CPU 60 stores the determined value of the flag F_MD in the EEPROM 67 and the onscreen image is switched to the live view (S108). When the OK button 46 is not pressed (S107:NO), control returns to step S105. After the step S108, the menu setting process subroutine is terminated.

Referring back to FIG. 7, the shooting operation is explained in detail. It is noted that before the shooting operation, the user manipulates the focusing ring 32 viewing the visual image through the eyepiece 2 so that the visual image is properly focus at the position of the field frame 22. If it is judged in step S006 that the release button 42 is pressed by half and a metering switch 421 is switched to ON (S006:YES), the CPU 60 performs metering operation based on an output signal from the CCD imaging device 16 (S007). Then, the CPU 60 performs exposure operation (S008). When the release button 42 is not pressed by half (S006:NO), control returns to step S004.

In step S009, it is judged whether the release button 42 is fully pressed and a release switch 422 is switched to ON. When the release switch 422 is ON (S009:YES), the CPU 60 checks the value of the flag F_MD. When the release switch 422 is not ON (S009:NO), control returns to step S004.

When it is determined in step S010 that the flag F_MD is 1, i.e., the focus correcting photographing mode is selected (S010:YES), control proceeds to S011 to perform shooting operation in the focus correcting photographing mode. When the flag F_MD is 0, i.e., the normal photographing mode is selected (S010:NO), control proceeds to step S016 to perform shooting operation in the normal photographing mode.

In step S011, the CPU 60 sends an instruction to the DSP 61 for performing a real exposure for a normal photographing image as a first frame image. The DSP 61, upon receipt of the instruction of a real exposure, performs unwanted charge discharging control and exposure control (charge storage time control) etc. for the CCD imaging device 16, and then reads out charge data (raw data) through the imaging signal processor 63, from the CCD imaging device 16 without thinning out the pixels and temporarily stores the data in the SDRAM 62 (S011).

The raw data is composed of image data R1, image data G1 and image data B1 respectively corresponding to red, green and blue light components. Then, The CPU 60 moves the reducing optical system 18 in a certain direction by a certain amount, through use of the reducing optical system driving controller 68 and the reducing optical system driving mechanism 19, based on correction data for blue light component that is previously stored in the spotting scope 10 (e.g., in the EEPROM 67) so as to obtain a focus corrected image for blue light as a second frame image (S012).

By moving the reducing optical system 18 by the certain amount in the certain direction based on the correction data, an image forming position of the object image of blue light component coincides with the receiving surface 161 of the CCD imaging device 16. The correction data includes a correction direction and a correction amount of the reducing optical system 18. The correction direction and amount for blue light component are determined longitudinal spherical aberration characteristics of the imaging optical system.

After the reducing optical system 18 is moved based on the correction data, the CPU 60 sends an instruction to the DRS 61 for performing a real exposure. The DSP 61, upon receipt of the instruction of a real exposure, performs unwanted charge discharging control and exposure control (charge storage time control) etc. for the CCD imaging device 16, and then reads out charge data (raw data) through the imaging signal processor 63, from the CCD imaging device 16 without thinning out the pixels.

The raw data is composed of image data R2, image data G2 and image data B2 respectively corresponding to red, green and blue light components. The CPU stores only the image data of B2 of blue light component in the SDRAM 62 (S013).

After continuous capturing of the two frames of images (the normal photographing image and the focus corrected image for blue light component) is finished, the CPU 60 reads the image data R1, image data G1, image data B1 and image data B2 to combine them with each other to produce an aberration corrected image (S014). The aberration corrected image is an image in which the longitudinal spherical aberration is corrected properly. In other words, the aberration corrected image is an normal photographing image of which blue component image data B1 is replaced with the blue component focus corrected image data B2.

Since the blue component focus corrected data B2 is not affected by the longitudinal spherical aberration, the aberration corrected image is produced as a high quality image not having color halation.

It should be noted that the normal photographing image is not affected by the longitudinal spherical aberration of red light component because red light halation caused by the longitudinal spherical aberration of red light is suppressed by the function of the infrared cut filter of which filtering performance is shown as spectral transmittance ST1 in FIG. 10. For this reason, in this embodiment, a focus corrected image for red light is not necessary. It is understood that the aberration corrected image may be composed of green component normal photographing data G1, blue component focus corrected image data B2 and red component focus corrected image data R2.

Next, the aberration corrected image as the raw data is subjected to a predetermined signal processing including a color process and gamma correction to be converted to image data (luminosity data Y, and color difference data Cr and Cb) by the DSP 61. The image data is then compressed and converted to image data having a certain image data format, such as a JPEG or TIFF format, by the image data compressor 65 (S015). Thus, image data for recordation having high image quality is obtained. After completion of step S015, control proceeds to step S017.

If it is determined that the flag F_MD is zero in step S010, i.e., the normal photographing mode is selected (S010:NO), only a normal photographing image is captured and image data for recordation is produced based on the normal photographing data (S016). It is understood that the normal photographing mode is preferably selected for a fast-moving object.

Further, the DSP 61 thins out the pixels from the generated image data for recording to generate a screen nail of a still image for displaying (for example 640×480 pixels), and displays the screen nail on the display panel 15 for a predetermined period of time (step S017). The DSP 61 stores the image data for recording into the memory card 100 (S018).

In step S019 the status of the main switch 41 is checked. When the main switch 41 is pressed again and thereby the power is turned off (S019:NO), the main controlling operation is terminated. When the main switch is ON (S019:YES), control returns to step S002.

Although the present invention has been described in considerable detail with reference to certain preferred embodiments thereof, other embodiments are possible. The above mentioned embodiment can also be applied to various types of optical instrument with a digital camera such as an astronomical telescope with a digital camera, a digital camera, and binoculars.

Although the telescope main body and the spotting scope according to the present invention have been described referring to the embodiment shown in the accompanying drawings, it is to be understood that the present invention is not limited to the foregoing embodiment, and that the constituents of the telescope main body and the spotting scope may be optionally substituted with different ones which have an equivalent function. Also, an additional constituent may be optionally incorporated in the spotting scope.

Although in the above mentioned embodiment the aberration corrected image is produced in the spotting scope 10, the producing of the focus corrected image (i.e., combining the normal photographing image and the focus corrected image for a particular color component) may alternatively performed in a external device such as a personal computer. In such a case, the normal photographing image and the focus corrected image captured in one shooting operation are inputted to the personal computer, for example, by use of the memory card 100, and a computer program running on the personal computer processes the inputted data (raw data) to generate the aberration corrected image.

In this case, the spotting scope 10 (the telescope main body 1) is not required to have the function of combining the normal photographing image and the focus corrected image. That is, the spotting scope 1 may be configured to only have the function of capturing the normal photographing image and the focus corrected image in one shooting operation.

The present disclosure relates to the subject matter contained in Japanese Patent Application No. 2003-377601, filed on Nov. 06, 2003, which is expressly incorporated herein by reference in its entirety.

1. An optical instrument, comprising:
an imaging optical system;
an imaging device that captures an object image formed through the imaging optical system;
a focus driving system that relatively moves an image forming position of the object image with respect to a receiving surface of the imaging device; and
a controller that controls the imaging device and the focus driving system,
wherein the controller obtains, in one shooting operation, continuously a normal photographing image and at least one focus corrected image which is captured when an object image of a certain color component is properly focused on the receiving surface of the imaging device, light of the certain color component causing a longitudinal spherical aberration when passing through the imaging optical system.

2. The optical instrument according to claim 1, wherein the controller operates to move the image forming position of the certain color component to the receiving surface of the imaging device based on correction data stored in the optical instrument so as to obtain the focus corrected image.

3. The optical instrument according to claim 1, wherein the certain color component includes one of a red component and a blue component.

4. The optical instrument according to claim 1, further comprising an image generating system that generates an aberration corrected image by combining image data of the certain color component in the at least one focus corrected image and image data of a color component other than the certain color component in the normal photographing image.

5. The optical instrument according to claim 4, wherein the color component other than the certain color component includes a green component.

6. The optical instrument according to claim 5, wherein the certain color component includes a blue component.

7. A telescope main body, comprising:
an objective optical system;
a focusing system including a focus adjusting member to be manipulated for focusing and a focusing lens which moves along a direction of an optical axis by operation of the focus adjusting member;
an imaging device which captures an object image formed through the objective optical system and the focusing lens;
a beam splitter which splits an optical path through the focusing lens into a first optical path directed to the imaging device and a second optical path directed to an ocular optical system provided in an eyepiece which is detachably attached to the telescope main body;
a focus driving system that relatively moves an image forming position of the object image with respect to a receiving surface of the imaging device; and
a controller that controls the imaging device and the focus driving system,
wherein the controller obtains, in one shooting operation, continuously a normal photographing image and at least one focus corrected image which is captured when an object image of a certain color component is properly focused on the receiving surface of the imaging device, light of the certain color component causing a longitudinal spherical aberration when passing through the imaging optical system.

8. The telescope main body according to claim 7, further comprising a focus adjusting optical system located on the first optical path.

9. The telescope main body according to claim 8, wherein the focus driving system moves the focus adjusting optical system with respect to the imaging device in a predetermined direction.

10. The telescope main body according to claim 9, wherein the controller operates to drive the focus adjusting optical system through the focus driving system to move the image forming position of the certain color component to the receiving surface of the imaging device based on correction data stored in the telescope main body so as to obtain the focus corrected image.

11. The telescope main body according to claim 7,
wherein an imaging optical system is formed by optical components including the objective optical system, the focusing lens and at least one other optical component located between the objective optical system and the receiving surface of the imaging device, and
wherein a focal length of the imaging optical system is not less than 800 mm on the basis of a 35 mm film.

12. The telescope main body according to claim 7, further comprising an image generating system that generates an aberration corrected image by combining image data of the certain color component in the at least one focus corrected image and image data of a color component other than the certain color component in the normal photographing image.

13. The optical instrument according to claim 12, wherein the color component other than the certain color component includes a green component.

14. The optical instrument according to claim 13, wherein the certain color component includes a blue component.

15. A telescope, comprising:
an ocular optical system;
an objective optical system;
a focusing system including a focus adjusting member to be manipulated for focusing and a focusing lens which moves along a direction of an optical axis by operation of the focus adjusting member;
an imaging device which captures an object image formed through the objective optical system and the focusing lens;
a beam splitter which splits an optical path through the focusing lens into a first optical path directed to the imaging device and a second optical path directed to the ocular optical system;
a focus driving system that relatively moves an image forming position of the object image with respect to a receiving surface of the imaging device; and
a controller that controls the imaging device and the focus driving system,
wherein the controller obtains, in one shooting operation, continuously a normal photographing image and at least one focus corrected image which is captured when an object image of a certain color component is properly focused on the receiving surface of the imaging device, light of the certain color component causing a longitudinal spherical aberration when passing through the imaging optical system.
